(19) United States
(12) Patent Application Publication
(10) Pub. No.: US 2003/0020754 A1
(43) Pub. Date: Jan. 30, 2003

(54) Method for improving accessibility of a computer display

(76) Inventor: Charles Leonard Berman, New York, NY (US)

Correspondence Address: McGuire Woods, LLP, 1750 Tysons Boulevard, Suite 1800, Tysons Corner, McLean, VA, 22102-3915, US

(21) Appl. No.: 09/912,380

(22) Filed: Jul. 26, 2001

(51) Int. Cl. G09G 5/00

(52) U.S. Cl. 345/767

(57) ABSTRACT

A method for improving the accessibility of a computer display begins with a fully laid out display containing one or more disjoint active regions and produces a (possibly hierarchical) set of active regions which are at least as accessible as the original regions and which are used as the basis of a display. If a visual display is desired, the resulting fully laid out display appears identical to the original; however, the task of positioning focus through movement requires less precise control than in the original. This is accomplished by intelligently analyzing and managing the active regions which comprise the interface. The active regions with which the process starts are disjoint and each is associated with one or more event handlers. The actions associated with the region is triggered by transferring focus to the region and causing one or more events for which handlers are present. This is typically done by positioning the cursor over the region and then clicking the mouse and/or typing one or more characters. The algorithm implemented by the invention extracts information from the relative positions of the active regions of the input display. It produces a hierarchically structured set of active regions which takes into account both the limitations of the user and the relationships among actions which are implied by the relative positions of the original active regions. The set of active regions may be realized visually or through speech (or other modalities) to communicate the information which is extracted from the display. If alternate modalities are used for presenting the information, the invention permits the information contained in the original visual/geometrical layout to be utilized in these other modalities.

### BACKGROUND OF THE INVENTION

### FIELD OF THE INVENTION

The present invention relates to computer human interaction and more particularly to a method for improving accessibility of a graphical computer interface by simplifying the positioning of the mouse cursor in the active regions which comprise the graphical user interface.

### BACKGROUND DESCRIPTION

In a computer system, a display refers to the region of the screen associated with an application together with the primary content which it contains. This content consists of two sorts of objects: primary content and active regions. The primary content may be text, images, or data entry controls. The primary content is passive with regard to interaction. The active regions consist of those parts of the display which accept input.

Active-regions can accept focus and, once they have focus, can accept input which is then processed by the application. From the standpoint of interaction, primary content is relevant only as it furnishes information concerning location of active regions and the input which such regions accept. Another way to say this is that the active regions are the parts of the display to which event handlers have been attached.

Hot links and data entry controls have both sorts of content. The text which underlies a hot link is part of the primary content while the region of the display in which a click activates the link is an active region. Active regions are typically indicated by secondary cues and are not positioned independently of the primary content with which they are associated. Examples include the color of a hot-link or modification of the cursor when it enters the active region or the blinking cursor in a text entry control with focus.

While modifying the active-regions may effect the actions which are required to interact with a display, this modification does not effect the placement of the primary content. It is this placement of primary content over which content producers are most concerned.

In a typical application, there will be one or more active region and, in order to interact successfully with the application, a user must be able to move focus to the active region of her choice and then to enter appropriate input. Focus may be shifted using any modality; however, today the most common modality is through use of the mouse. This process of shifting the focus of an application is referred to as navigating the display.

Accessibility refers to the ease with which a user may select among the alternative actions presented by an application. Intuitively, the accessibility of a display depends on both the abilities of a particular user and on the layout/behavior of the display itself. When using a mouse to navigate in a display, each action is generally associated with a region of the display. Because of this, the accessibility of a region will be referred to in the following discussion when it would be more accurate to refer to the accessibility of the actions associated with a region.

Interactive applications frequently require users to position and click the mouse with a high degree of accuracy. This is a problem for elderly and disabled persons who may not possess the degree of motor control required.

### SUMMARY OF THE INVENTION

It is therefore an object of the present invention to provide a method for improving the accessibility of a computer display.

The invention is a process which begins with a fully laid out display containing one or more disjoint active regions, and produces a structured interface which can be implemented with another fully laid out display in which the task of positioning focus through mouse movement requires less precise control than in the original display. Alternatively, the structured interface can be implemented using speech or other modalities. This is accomplished by intelligently analyzing and managing the active regions which comprise the interface.

The active regions with which the process starts are disjoint and each is associated with one or more event handlers. The actions associated with the region is triggered by transferring focus to be region and causing one or more events for which handlers are present. This is typically done by positioning the cursor over the region and then clicking the mouse and/or typing one or more characters.

The algorithm implemented by the invention extracts information from the relative positions of the active regions of the input display. It produces a structured interface which takes into account both the limitations of the user and the relationships among actions which are implied by the relative positions of the original active regions.

This new interface may be visual or it may use speech (or other modalities) to communicate the information which is extracted from the display. If alternate modalities are used for presenting the information, the invention permits the information contained in the original visual/geometrical layout to be utilized in these other modalities.

Aside from increasing the accessibility of the display, the invention include a number of additional features. For example, if desired, the invention can increase accessibility without effecting the placement of content on a page. The invention can be personalized depending on the capabilities of the user.

The invention analyzes the layout of the page, extracts information contained in the layout and uses this information to organize the active regions. The invention determines a maximal active region associated with each given initial active region by using a Voronoi diagram based on points which include the vertices of the initial active regions. The invention expands the initial active region within the maximal active region in order to make the region accessible without effecting the original interface. The invention clusters inaccessible active regions hierarchically according to their geometrical relationship. The invention provides access to the originally inaccessible region through an alternate display method which accommodates the users limitations and is based on the original layout.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 illustrates a web page with active regions indicated by solid rectangles;

FIG. 2 is a flow chart showing the entire process according to the invention;

FIG. 3 illustrates the same web page as shown in FIG. 1 with the Voronoi regions indicated by dashed lines; and

FIG. 4 illustrates the same web page as shown in FIG. 1 in which solid lines indicate the final active regions produced by the algorithm implemented by the invention.

### DETAILED DESCRIPTION OF A PREFERRED EMBODIMENT OF THE INVENTION

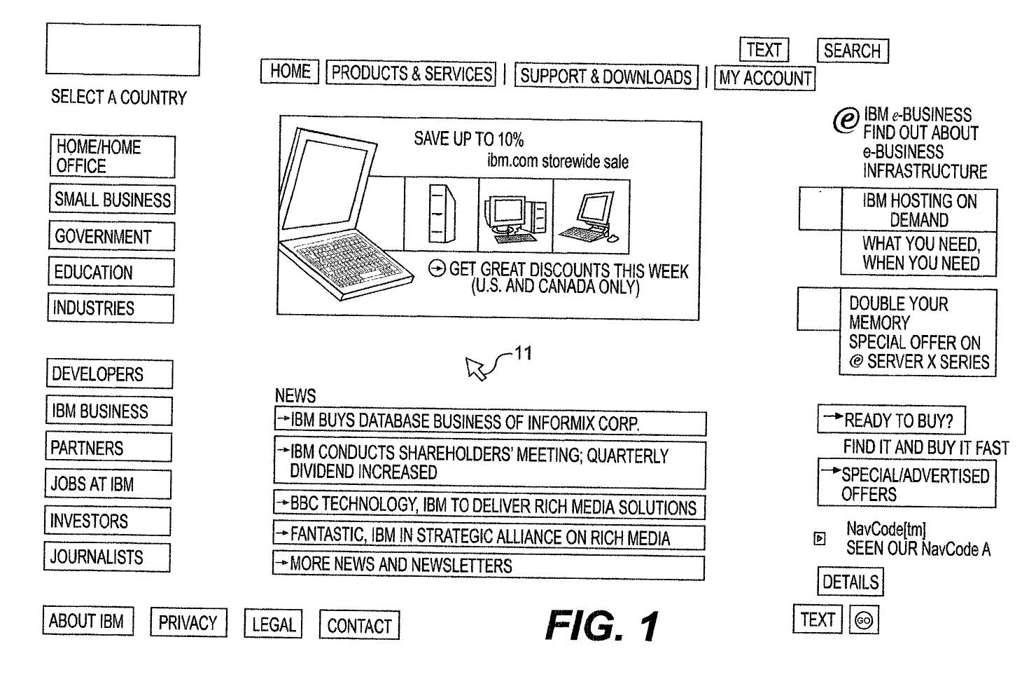

Referring now to the drawings, and more particularly to FIG. 1, there is shown an illustrative web page which will be used to show the process implemented by the present invention. In FIG. 1, the solid lines outline the initial active regions in the web page. These lines are not visible in the web page but are shown in FIG. 1 to differentiate the many active regions of this particular web page. By moving a pointing cursor, such as the arrow 11, over one of these active regions under the control of a pointing device, such as a mouse, and clicking a button on the pointing device, a link from the active region to an anchor page is activated. The process of moving the pointing cursor over a desired active region and selecting it by clicking on it is generally referred to as “navigating” the display.

A user's ability to navigate in a display may depend on many factors. For simplicity, it is assumed that these factors can be summarized in a single positive number which will be referred to as the user's control-dimension. It is assumed that the larger a user's control-dimension, the more easily he or she can navigate a display with the mouse and that a control-dimension of “0” indicates a complete inability to navigate using the mouse. Roughly speaking, the control-dimension measures the level of control that the user is able to exercise with respect to positioning and clicking the mouse. Note that this dimension can reflect visual and motor control impairment.

Modeling the accessibility of a display is a complex problem. Rather than trying to model the complex effects that the relative positioning of different active regions have on the accessibility of a display as a whole, a simplifying assumption is made that the accessibility of a display containing a number of active regions is the minimum of the accessibility of these regions. Using this assumption, the simpler problem of defining and improving accessibility for a region in a display is solved.

An accessibility function is used to measure accessibility of a region in a display. An accessibility function is a monotonic function from a partially ordered domain to the real numbers. The domain consists of

{(r,t)|r is contained in the display and 0≦t}.

Here, the first component of the domain corresponds to the active regions of the display, and the second component corresponds to the capability-measure. The partial order is induced by the containment partial order on the regions and the natural order on the positive reals.

The first component (planar region) corresponds to the region in the display, the second component (capability-measure) measures of how well the user can manipulate the mouse. The monotonicity condition reflects the observation that if one active region contains another, the containing region must be more accessible than the subset.

For a user with control-dimension, c, a region, r, is accessible with respect to accessibility function, f, if f(r,c)>0.

There is no perfect accessibility function. Some simple examples, which satisfy the monotonicity constraints, have the form:

f(region,control)=b×m(region)−a/control,

where b>0 and m is monotonic in the region. The first term of such an accessibility function expresses the idea that bigger regions are more accessible than smaller. The second term expresses the barrier which must be overcome in order for a region to be accessible to a user.

Possible measures, m, for the region include:

Let r be an inscribed rectangle of maximal area. Let m(r)=|r|^{s} where s>0 and |r| is the area of r and s>0.

Let r be an inscribed circle of maximal area. Again, let m(r) be a positive power of the radius of r.

Any monotonic function of the length and height of a maximal inscribed rectangle. This would permit regions with aspect ratios far from 1 to be valued less highly than those whose maximal inscribed rectangles are squares.

The preferred embodiment of the invention uses f(r,c)=side_maximal_inscribed_square−(1/capability_measure)

The capability-measure summarizes the ability of a user to navigate the display using a mouse. It might be supplied by (or on behalf of) the user, or by extracted automatically by analyzing the motion of the mouse.

One reasonable capability-measure would be the precision with which someone can comfortably position and click. This capability-measure varies for a given individual for reasons such as mouse-type and level of anxiety or tiredness. It varies even more between people.

The present invention begins with a display which has been fully “laid-out” and which contains one or more disjoint active regions, as shown in FIG. 1. Each active region is associated with an action which is triggered by positioning the cursor over the region and then clicking the mouse and/or typing one or more characters.

The algorithm implemented by the invention extracts information from the relative positions of the active regions of the input display. It produces a structured interface which takes into account both the limitations of the user and the relationships among actions which are implied by the relative positions of the original active regions. This new interface may be visual or it may use speech (or other modalities) to communicate the information which is extracted from the display. One advantage of this approach is to permit the information contained in relative positioning of content to be utilized in displays which use other modalities.

For example, the algorithm proceeds by clustering active regions hierarchically. If the desired output display uses voice, this hierarchy can be realized by associating spoken menus with each node in the hierarchy. The resulting audio interface reflects the interrelationships implied by the original visual display.

The algorithm consists of two phases. In the first, the control-dimension and the geometry of the initial display is used to group actions hierarchically. In the second, an interactive display is constructed. The new interface is described in visual terms; however, as noted, the interface could be realized using other modalities.

A major advantage of the algorithm is that it discovers and presents the information contained in the original visual layout in a form appropriate for the limitations of the user. Another advantage is that if a visual display is produced, the resulting display does not change the placement of any of the primary content on the display. If the resulting display is visual, positioning focus in the new display through mouse movement requires less precise control than in the original display.

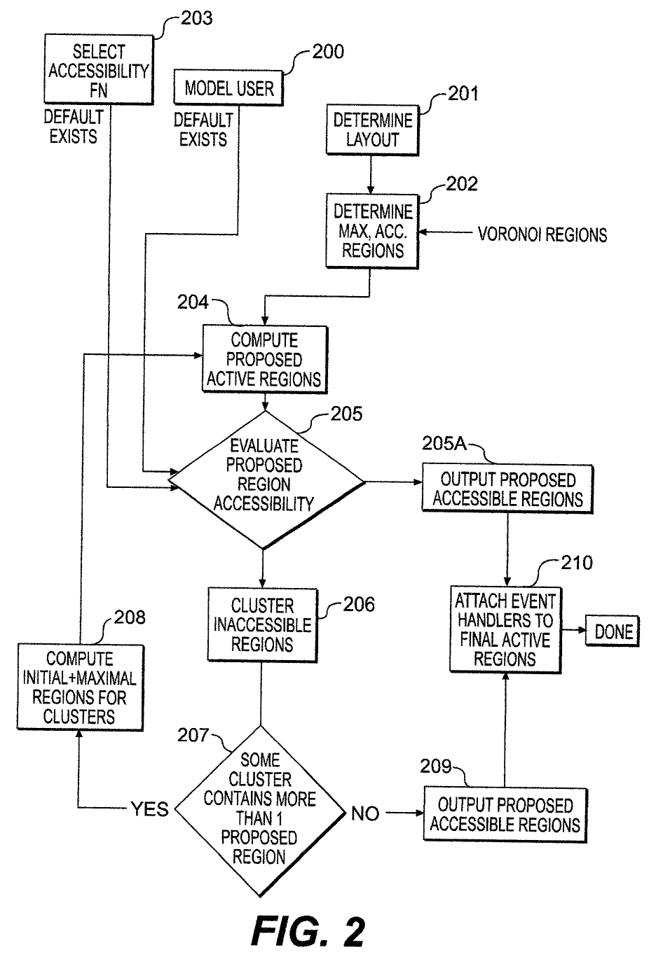

The process is shown in the flow chart of FIG. 2. The inputs are a user model 200, the web page layout 201 and an accessibility function 203. The user model 200 represents the user's abilities to use the mouse by a vector Mu which is monotonic in the user's capabilities. That is, if the user is more capable than another user with respect to a factor measured by a given dimension (say dimension j) of this vector, then M1[j]>M2[j]. For simplicity, this vector is assumed to be of dimension 1 and is called the capability-measure. The invention does not include a method for determining the capability-measure; however, it does include the use of the capability-measure in performing layout. “Click precision” is used as a capability measure.

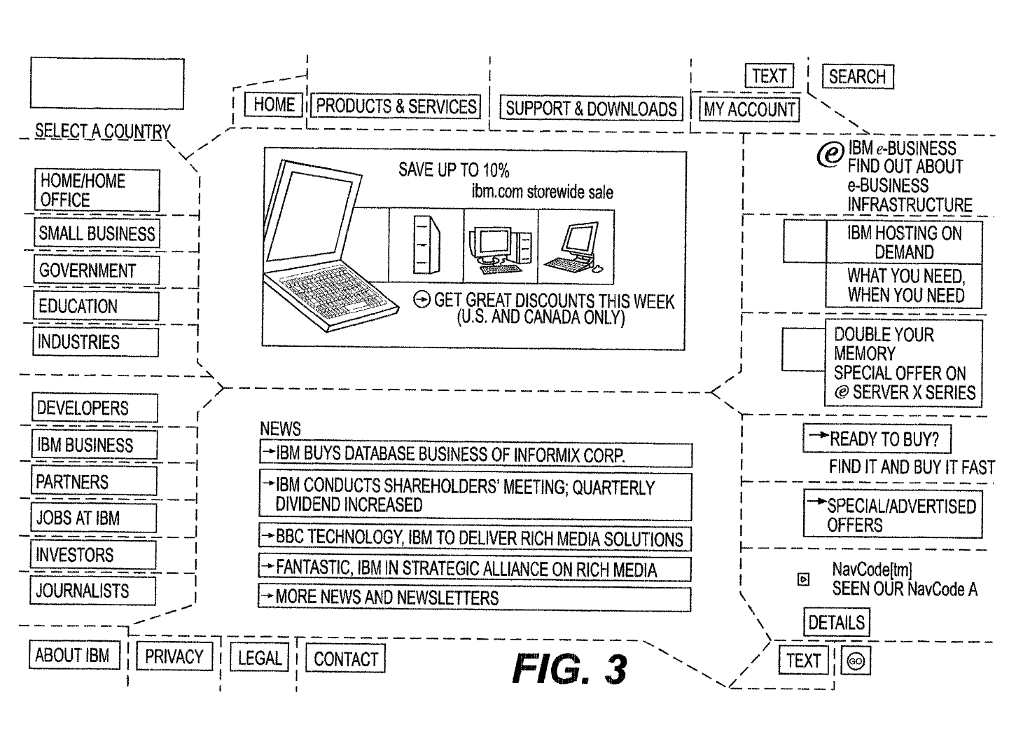

The initial active regions, Aᵢ, of the web page layout 201 are first determined. Then, in function block 202, the maximal potential active regions are determined. These are disjoint regions Vᵢ, each containing Aᵢ, whose union is contained in the display. A particular method for determining these Vᵢ, which uses the Voronoi diagram, is implemented in the preferred embodiment. Each Voronoi region, Vᵢ, consist of all points, p, such for all Aⱼ≠Aᵢ, distance (p, Aᵢ)<distance (p, Aⱼ). The final maximal areas are the intersections of the Voronoi regions with the display area. There are well known algorithms to compute this set. See, for example, Franz Aurenhammer, “Voronoi diagrams—a survey of a fundamental geometric data structure”, ACM Computing Surveys, Volume 23, Issue 3 (1991), pp. 345-405. If adjacent regions have exactly the same event handlers, merge them. The result is shown in FIG. 3 where the dashed lines are the boundaries of the Voronoi diagram. These are the maximal potential active regions.

An accessibility function is selected in input 203. This function measures the accessibility of a region to a user. The example accessibility function (1) shown above is used. The invention does not include a method for choosing an accessibility function; however, it does include the use of a monotonic accessibility function to guide layout.

A processing loop is then entered in function block 204 where, for each initial active region, Aᵢ, a proposed active region, Bᵢ, is determined. The proposed active region Bᵢ contains Bᵢ and is contained in Vᵢ. The proposed active regions should be contained in the maximal regions constructed above and, in turn, contain the initial active regions. If the desired display is not visual, use Vᵢ as the proposed active region. For a visual display, Aᵢ can be expanded within Vᵢ. If Aᵢ is polygonal, the vertices might be moved outwards along their angle bisectors. If Aᵢ is rectangular, methods might grow the rectangle by extending the shortest side.

The accessibility function of each proposed active region Bᵢ is evaluated in function block 205. If Bᵢ is adequately accessible, Bᵢ is output at function block 205a as the final active region for the action(s) originally associated with region(s) Aᵢ. If not, the maximal active regions corresponding to Bᵢ which were not processed in step 205a are clustered in function block 206.

The goal of clustering is to produce a region with improved accessibility which is associated with a number of initial active regions. The clustering process will use the information concerning the geometry of the input display and the user's capabilities; however, in order to be truly effective in improving accessibility, it must also take into account the characteristics of the output device.

The characteristics of the output device are encapsulated in a function which is called “beneficialMerge”. This function takes two regions as arguments and returns a measure of the effect on accessibility which, combining the two regions, will have on the final display. In the preferred embodiment, this measure is a Boolean value which either permits or forbids a merge; however, the same principle could be applied to a function which returned a numerical estimate of the effect of a merge.

The motivation and use of the beneficialMerger function are best illustrated through examples: If the target display uses speech, beneficialMerge might enforce a limit preventing more than five items being clustered at a single level of the hierarchy, thus avoiding excessively long lists which must be spoken. (The precise limitation could be chosen by the user during configuration.) If the target display is visual, a merge would be prevented if the resulting cluster has more elements than can be (accessibly) displayed within the available screen area.

Any algorithm can be used to group regions. The following algorithm proceeds by combining regions with the largest common border. For each inaccessible region or cluster, calculate the perimeter of the proposed active region (for a cluster use the sum of the perimeters of the contained proposed active regions). For each edge shared by two inaccessible regions or clusters, r₁ and r₂, if beneficialMerge(r₁, r₂) is true, assign a weight to the edge equal to

length×length/(perimeter1×perimeter2);

otherwise, assign a weight of 0. Coalesce the two regions or clusters which share the edge with largest (non-zero) weight. End iteration

A determination is made in decision block 207 as to whether some cluster, Cⱼ, contains more than a single proposed region Bᵢ. If so, then in function block 208, for each cluster, Cⱼ, let the maximal active region, Vᵢ, of Cᵣ be the union of the maximal active regions for its elements and let the initial active region, Aᵣ, of Cᵣ be the convex hull of the initial active regions (restricted to lie in the maximal active region) of its elements. The process then loops back to function block 204. If all clusters, Cⱼ, contain only a single proposed region, Bᵢ, the process goes to function block 209 where, for any regions, Bⱼ, that have not been processed in function block 205a, Vⱼ is used as the final active region.

Event handlers are attached to the final active regions to handle events which occur in them in function block 210, and the process is complete. In function block 210, event handlers are adjusted so that each final active region handles all events handled by any initial active region which it contains. For mouse-over and mouse-move events, give feedback that the final region has been entered. This feedback is configurable and could be, for example, brightening the final region, possibly with an audible cue, and/or enlarging the maximal region. For other events with handlers in the original display, open a more accessible display of the final active region. This display could be a magnified rendering of the maximal active area or an audible presentation of the primary content of the associated initial area(s). The user interacts using this more accessible display. A simple configurable action is provided (such as hitting the escape key) which permits the user to return to the original display.

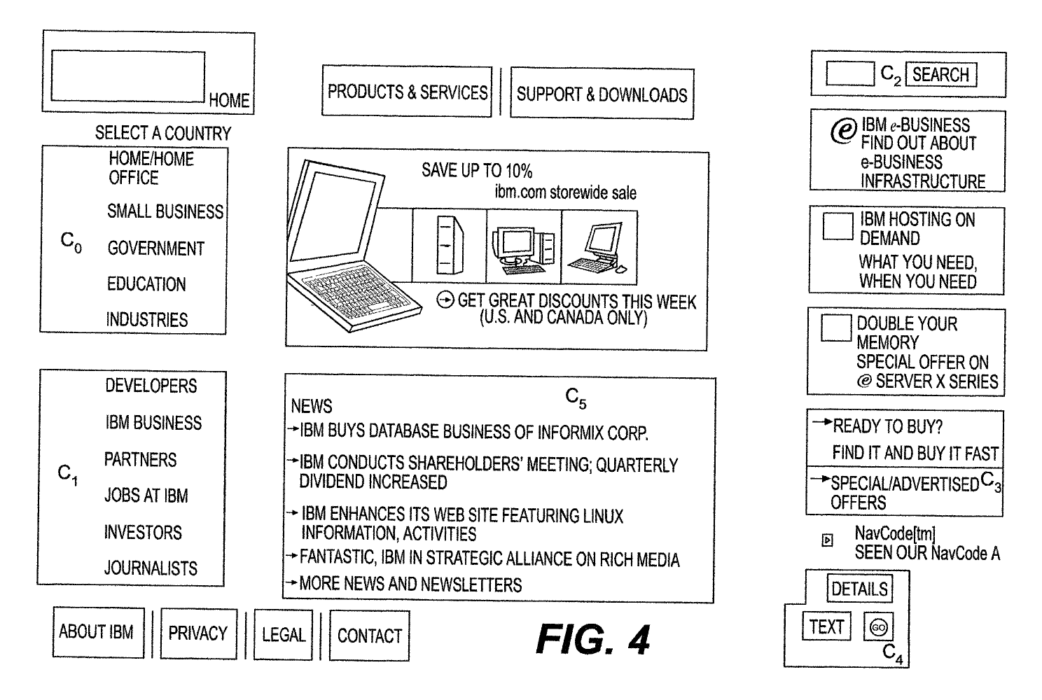

FIG. 4 shows the result of the process where the solid lines indicate the final active areas after clustering. Different user capabilities could have resulted in different clusters, so the illustration in FIG. 4 is merely one possible example.

While the invention has been described in terms of a single preferred embodiment, those skilled in the art will recognize that the invention can be practiced with modification within the spirit and scope of the appended claims.

Having thus described my invention, what I claim as new and desire to secure by letters patent is as follows:

1. A method for improving accessibility of a computer interface by simplifying positioning of focus in active regions which comprise a graphical user interface, the method comprising the steps of:
inputting an original display, accessibility function and a control-dimension, the display including a number of disjoint initial “active” regions, Aᵢ, used for interaction and, for each region, one or more methods to be invoked when events occur in the region;
constructing new active regions, personalized for an individual user which are at least as accessible as the initial active regions; and
outputting the active regions with an association of the regions to event handlers included in the original display.

2. The method for improving accessibility of a computer interface recited in claim 1, wherein the constructed new active regions are arranged hierarchically.

3. The method for improving accessibility of a computer interface recited in claim 1, wherein if a visual display is desired, further comprising the step of outputting a display which includes a number of new active regions and associated methods which are used for interaction, the new display permitting all original methods to be invoked.

4. The method for improving accessibility of a computer interface recited in claim 3, wherein the step of constructing new accessible active regions comprises the steps of:
associating with each active region a maximal active region, Vᵢ, such that the Vᵢ are disjoint;
determining proposed active regions each contained in Vᵢ and containing active regions, Aᵢ, the determination being done using a control measure which reflects capabilities of a user; and
hierarchically clustering active regions which are not accessible.

5. The method for improving accessibility of a computer interface recited in claim 4, wherein the step of associating with each active region a maximal active region is performed by using a Voronoi region of an active region as its maximal active region.

6. The method for improving accessibility of a computer interface recited in claim 4, wherein the step of determining proposed active regions comprises the steps of:
if the desired interface is non-visual, using the maximal active region as the proposed active regions; but
if the desired interface is visual, growing the initial active region by extending active regions within the maximal active region.

7. The method for improving accessibility of a computer interface recited in claim 4, wherein the step of hierarchically clustering the active regions comprises the step of repeatedly clustering the active regions, treating resulting clusters as new active regions and repeating the method until clustering does not combine any distinct regions.

8. The method for improving accessibility of a computer interface recited in claim 7, wherein clustering is performed by combining adjacent regions based on a percentage of perimeter which two regions share and subject to constraints embodied by a beneficialMerge function, the active regions constructed being called final proposed active regions.

9. The method for improving accessibility of a computer interface recited in claim 3, wherein the step of constructing new accessible active regions comprises the steps of:
associating with each active region a maximal active region, Vᵢ, such that the Vᵢ are disjoint, the step of associating with each active region a maximal active region is performed by using a Voronoi region of an active region as its maximal active region;
determining proposed active regions each contained in Vᵢ and containing active regions, Aᵢ, the determination being done using a control measure which reflects capabilities of a user, the step of determining proposed active regions including the steps of:
if the desired interface is non-visual, using the maximal active region as the proposed active regions, but
if the desired interface is visual, growing the initial active region by extending active regions within the maximal active region; and
hierarchically clustering active regions which are not accessible, the step of hierarchically clustering the active regions including the steps of:
repeatedly clustering the active regions, and
treating resulting clusters as new active regions and repeating the method until clustering does not combine any distinct regions.

10. The method for improving accessibility of a computer interface recited in claim 2, wherein for a non-visual interface, a resulting hierarchical grouping of active regions is used as a basis for a series of menus which permit a user to activate all of the interfaces initial functionality.

11. The method for improving accessibility of a computer interface recited in claim 1, wherein for a visual interface, a display is realized by associating event handlers from initial active regions with a final proposed active region containing an initial active region.

12. The method for improving accessibility of a computer interface recited in claim 11, wherein when a pointing cursor enters a final proposed active region, visual feedback is given to a user to indicate that focus has reached an initial region.

13. The method for improving accessibility of a computer interface recited in claim 12, wherein if a final cluster contains a single initial region, the event handlers of the original region are triggered whenever an event occurs in the final proposed region.

14. The method for improving accessibility of a computer interface recited in claim 11, wherein if a final cluster contains two or more initial regions, when any event occurs in a final region, further comprising the step of presenting the final region in a new magnified window.
